(19) United States
(12) Patent Application Publication
(10) Pub. No.: US 2019/0271343 A1
(43) Pub. Date: Sep. 5, 2019

(54) HEIGHT ADJUSTABLE MAGNET FASTENER

(71) Applicant: FORD GLOBAL TECHNOLOGIES, LLC, Dearborn, MI (US)

(72) Inventors: Jesus Manuel Perez Hernandez, Mexico City (MX); Edgar Javier Ortega Garcia, Tlalnepantla (MX); Eric Vargas Linan, Metepec (MX)

(21) Appl. No.: 15/911,992

(22) Filed: Mar. 5, 2018

(51) Int. Cl. F16B 5/12; B60R 13/02; B62D 27/06; A47G 1/17

(52) U.S. Cl. CPC F16B 5/123; B60R 13/0206; F16B 2001/0035; A47G 1/17; B62D 27/06

(57) ABSTRACT

A magnet fastener includes a base, a magnet carrier held in the base, a magnet held in the magnet carrier, a first pin receiver in the base, a second pin receiver in the magnet carrier and a pin received in the first pin receiver and the second pin receiver. A method of securing a headliner to a metal roof substrate is also provided.

### TECHNICAL FIELD

This document relates generally to the motor vehicle equipment field and, more particularly, to a new and improved height adjustable magnet fastener that may be utilized to, for example, attach a headliner to the sheet metal roof of a motor vehicle.

### BACKGROUND

A magnet fastener may be utilized to attach the headliner to the roof sheet metal substrate of a motor vehicle. In certain motor vehicles, the design and shape of the headliner and/or the roof sheet metal lead to a variance of the clearance between the two parts across the area of overlap. This document relates to a new and improved magnet fastener. This improved magnet fastener may be adjusted to compensate for clearance variation thereby allowing a common magnet fastener design to be utilized instead of two different magnet fasteners of different heights. This reduces costs, simplifies assembly and represents a significant advance in the art.

### SUMMARY

In accordance with the purposes and benefits described herein, a new and improved magnet fastener is provided. That magnet fastener comprises a base, a magnet carrier held in the base, a magnet held in the magnet carrier, a first pin receiver in the base, a second pin receiver in the magnet carrier and a pin received in the first pin receiver and the second pin receiver.

More specifically, the base may include a doghouse. That doghouse may include upstanding walls and an entry slot.

The magnet carrier may be held in the doghouse. The magnet carrier may include an umbrella and a stem. The umbrella may include a recessed base adapted for holding the magnet. Further, the magnet carrier may include a stabilizer disc. In such an embodiment the stem includes a first end and a second end with the umbrella carrier provided at the first end and the stabilizer disc provided at the second end.

The second pin receiver may include a plurality of apertures provided at spaced locations through the stem of the magnet carrier. The pin that connects the magnet carrier to the base may comprise a cotter pin.

In one possible embodiment of the magnet carrier, the magnet carrier further includes an anti-rotation feature. That anti-rotation feature may include a keyhole-shaped slot on the base and a projecting rib on the magnet carrier which may slide through the keyhole-shaped slot for height adjustment while locking the magnet carrier against rotation in the base.

In accordance with an additional aspect, a method is provided of securing a headliner to a metal roof substrate. That method comprises the steps of adjusting height of a magnet carrier in a base of a magnet fastener, fixing the magnet carrier in the base by a pin and securing the headliner to the metal roof substrate with the magnet fastener.

The method may further include the step of fixing the base to the headliner. Further, the method may include securing the magnet carrier against rotation with respect to the base.

The step of adjusting the height of the magnet carrier may include the steps of aligning a first pin receiver in the base with a second pin receiver in the magnet carrier and then inserting the pin into the first pin receiver and the second pin receiver. Still further, the second pin receiver may include a plurality of apertures provided at spaced locations through a stem of the magnet carrier. In such an embodiment, the method may include selecting a particular aperture of the plurality of apertures in which to insert the pin thereby adjusting the position of the magnet carrier with respect to the base and the overall height of the magnet fastener.

In the following description, there are shown and described several preferred embodiments of the magnet fastener as well as the related method of securing a headliner to a metal roof substrate. As it should be realized, the magnet fastener and the related method are capable of other, different embodiments and their several details are capable of modification in various, obvious aspects all without departing from the magnet fastener and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the magnet fastener and the related method of securing a headliner to a metal roof substrate and together with the description serve to explain certain principles thereof.

FIG. 1 is an exploded perspective view of the magnet fastener.

FIG. 2 is a side elevational view of the magnet fastener assembled in a first height configuration.

FIG. 3 is a view similar to FIG. 2 but illustrating the magnet fastener assembled in a second height configuration.

FIG. 4 is a schematic cross-sectional view illustrating how the magnet fastener of claims 1-3 is utilized to secure a headliner to a metal roof substrate of a motor vehicle.

FIG. 5 is a cross-sectional view illustrating an alternative embodiment of the magnet fastener incorporating an anti-rotation feature which prevents the magnet carrier from rotating in or with respect to the base to which it is attached.

Reference will now be made in detail to the present preferred embodiments of the magnet fastener and the related method of securing a headliner to a metal roof substrate, examples of which are illustrated in the accompanying drawing figures.

### DETAILED DESCRIPTION

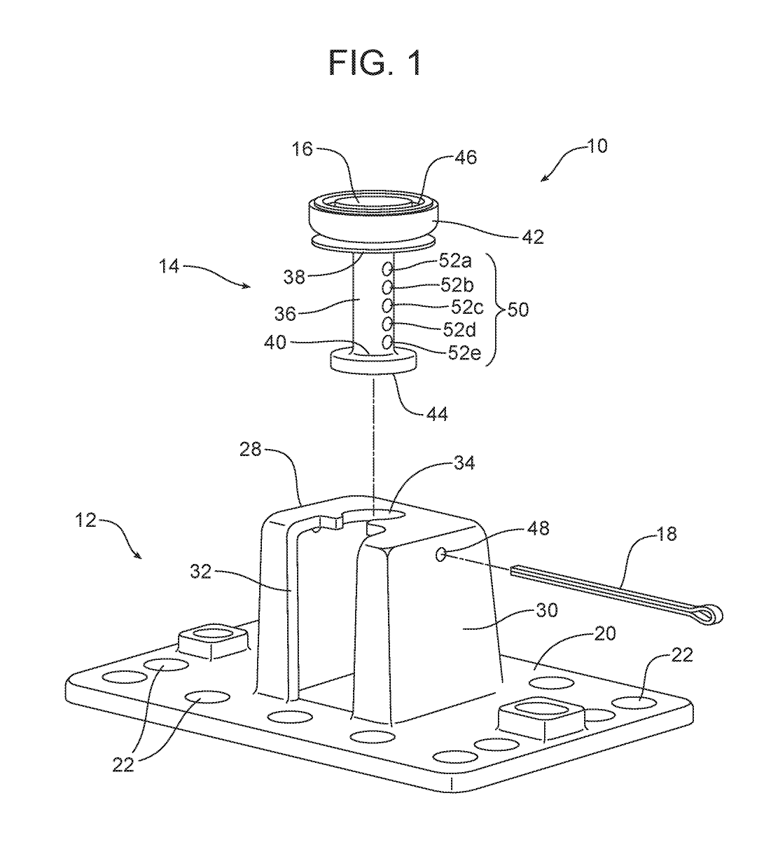

Reference is now made to FIG. 1, which is an exploded perspective view of the new and improved magnet fastener 10. That magnet fastener 10 includes a base 12, a magnet carrier 14, a magnet 16, held in the magnet carrier, and a pin 18 for securing the magnet carrier 14 to the base 12. In the illustrated embodiment, the pin 18 is a cotter pin.

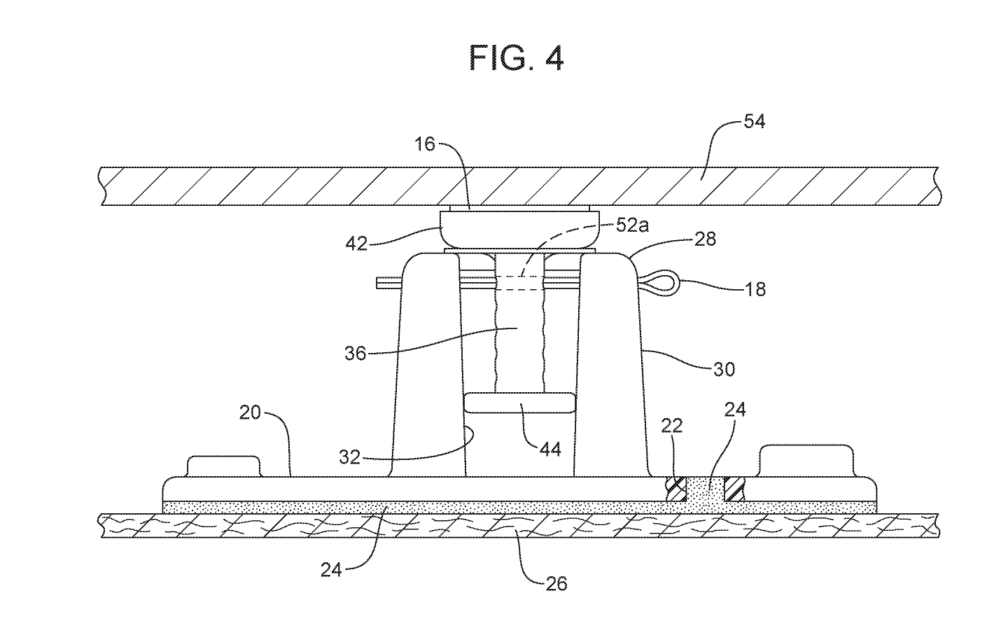

In the illustrated embodiment, the base 12 includes a mounting flange 20 having a plurality of apertures 22. The apertures 22 are adapted to hold an adhesive 24 used to secure the base 12 to a headliner 26 as illustrated in FIG. 4.

The base 12 also includes a doghouse 28 comprising the upstanding walls 30 projecting upwardly from the mounting flange 20 and defining an entry slot 32 in communication with a magnet carrier receiver 34. The base 12 may be made from any appropriate material including being molded from plastic or composite materials.

The magnet carrier 14 includes a stem 36 having a first end 38 and a second end 40. The magnet carrier 14 also includes an umbrella 42 provided at the first end 38 and a stabilizer disc 44 provided at the second end 40. In the illustrated embodiment, the umbrella 42 includes a recessed basin 46 adapted to receive and hold the magnet 16. The magnet carrier 14 may be made from any appropriate material including being molded in a single piece from plastic or composite materials. When the magnet fastener is fully assembled, the stem 36 of the magnet carrier 14 passes through the entry slot 32 and is held in the magnet carrier receiver 34 provided in the doghouse 28 of the base 12.

The magnet fastener 10 includes a height adjustment feature comprising (a) a first pin receiver 48 in the base 12 and, more particularly, the doghouse 28 of the base, and (b) a second pin receiver 50 in the magnet carrier 14. In the illustrated embodiments, that second pin receiver 50 includes a plurality of apertures 52a-52e provided at spaced locations through the stem 36.

One assembles the magnet fastener 10 by inserting the magnet carrier 14 into the doghouse 28 of the base 12 through the entry slot 32 until the stem 36 extends through the magnet carrier receiver 34. One then aligns the first pin receiver 48 in the base 12 with any one of the second pin receiver apertures 52a-52e. Here it should be appreciated that the aperture 52a-52e selected and aligned with the first pin receiver 48 provides for height adjustment of the magnet fastener 10.

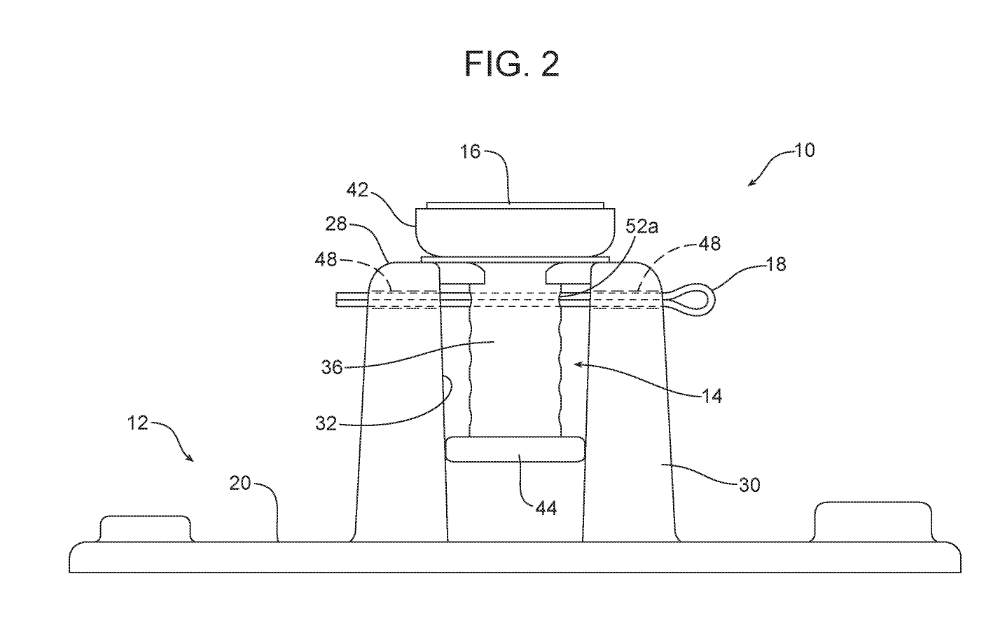

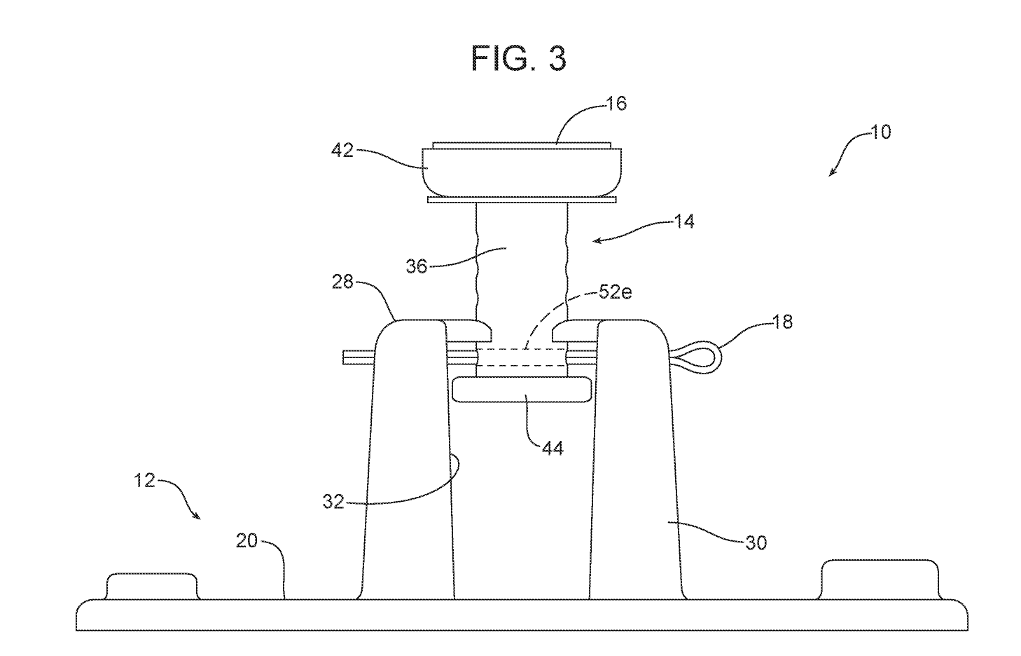

Thus, for example, as illustrated in FIG. 2, when the second pin receiver aperture 52a is aligned with the first pin receiver 48 and the pin 18 is inserted through those aligned apertures, the magnet fastener 10 is in its lowest height configuration. In contrast, when the second pin receiver aperture 52e is aligned with the first pin receiver 48 and the pin 18 is inserted through those aligned pin receivers, the magnet fastener 10 is in its highest height configuration as illustrated in FIG. 3. Here it should be appreciated that the second pin receiver apertures 52b, 52c and 52d provide for intermediate height positions between the lowest height configuration illustrated in FIG. 2 and the highest height configuration illustrated in FIG. 3.

The magnet fastener 10 illustrated in FIGS. 1-3 is useful in a method of securing a headliner 26 to a metal roof substrate 54 of a motor vehicle (see FIG. 4). That method includes adjusting the height of the magnet carrier 14 in the base 12 of the magnet fastener 10 by aligning the first pin receiver 48 in the base 12 with any one of the second pin receiver apertures 52a-52e in the stem 36 of the magnet carrier 14 required for a particular application and then inserting the pin 18 into the first pin receiver and the selected second pin receiver aperture. As noted above, the pin 18 functions to fix the magnet carrier 14 in the base 12. The method also includes the step of securing the headliner 26 to the metal roof substrate 54 with the magnet fastener 10.

More particularly, the method includes the step of fixing the base 12 to the headliner 26 by means of adhesive 24. As noted previously, that adhesive 24 may extend into the apertures 22 in the mounting flange 20 of the base 12 to provide a more secure interlocking of the base to the headliner. With the magnet fastener 10 secured to the headliner 26, it is a relatively simple matter to position the headliner 26 with respect to the metal roof substrate 54 and bring the magnet 16 carried by the magnet carrier 14 into engagement with the metal roof substrate in order to secure the headliner into position.

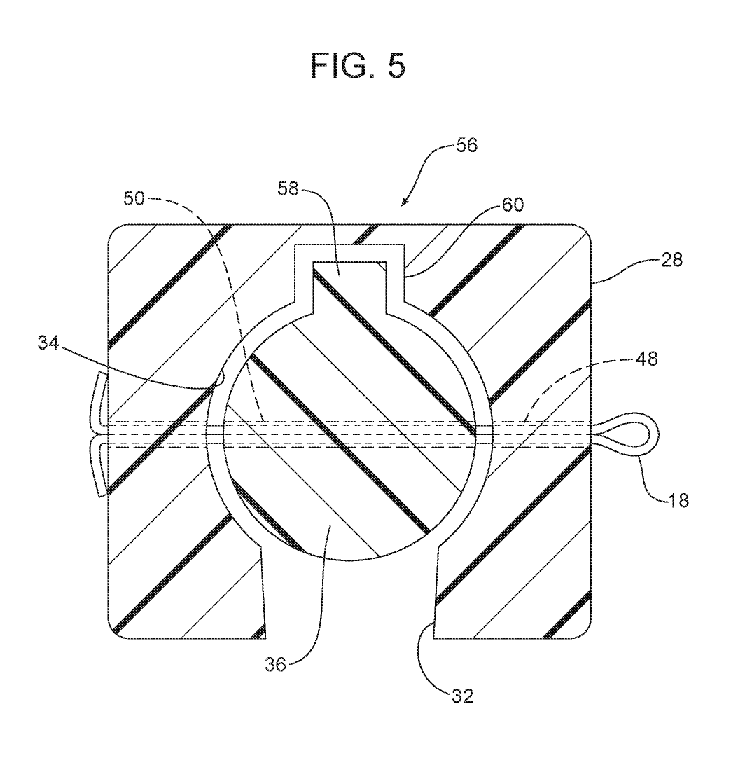

FIG. 5 illustrates an alternative embodiment of the magnet fastener 10 incorporating an anti-rotation feature 56. More specifically the anti-rotation feature 56 comprises (a) a rib 58 running along the length of the stem 36 and (b) a magnet carrier receiver 34 in the form of a keyhole-shaped slot. The channel portion 60 of the keyhole-shaped slot is sized and shaped to receive the rib 58 when the magnet carrier 14 is secured in position in the base 12 by means of the pin 18 passing through the aligned first pin receiver 48 in the base and second pin receiver 50 in the magnet carrier 14. As should be appreciated, the sidewalls of the rib 58 engage the walls of the channel 60 preventing relative rotation between the magnet carrier 14 and the base 12 thereby forming the anti-rotation feature 56. Significantly, such an alternative embodiment of the magnet fastener 10, as illustrated in FIG. 5, is useful in a method including the step of securing the magnet carrier 14 against rotation with respect to the base 12. This anti-rotation feature 56 may be useful in certain applications and uses of the magnet fastener 10.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A magnet fastener, comprising:
a base including a doghouse having at least one upstanding wall and an entry slot;
a magnet carrier held in said base;
a magnet held in said magnet carrier;
a first pin receiver in said base;
a second pin receiver in said magnet carrier; and
a pin received in said first pin receiver and said second pin receiver.

2. (canceled)

3. The magnet fastener of claim 1, wherein said magnet carrier is held in said doghouse.

4. The magnet fastener of claim 3, wherein said magnet carrier includes an umbrella and a stem.

5. The magnet fastener of claim 4, wherein said second pin receiver includes a plurality of apertures provided at spaced locations through said stem.

6. The magnet fastener of claim 5, wherein said umbrella includes a recessed basin holding said magnet.

7. The magnet fastener of claim 6, wherein said magnet carrier includes a stabilizer disc.

8. The magnet fastener of claim 7, wherein said stem includes a first end and a second end.

9. The magnet fastener of claim 8, wherein said umbrella is provided at said first end and said stabilizer disc is provided at said second end.

10. (canceled)

11. The magnet fastener of claim 9, wherein said pin is a cotter pin.

12. The magnet fastener of claim 1, further including an anti-rotation feature.

13. The magnet fastener of claim 12, wherein said anti-rotation feature includes a keyhole-shaped slot on said base and a projecting rib on said magnet carrier.

14. A method of securing a headliner to a metal roof substrate, comprising:
adjusting a position of a magnet carrier in a base of a magnet fastener;
fixing said magnet carrier in said base by a pin; and
securing said headliner to said metal roof substrate with said magnet fastener.

15. The method of claim 14, including fixing said base to said headliner.

16. The method of claim 15, including securing said magnet carrier against rotation with respect to said base.

17. The method of claim 16, wherein adjusting said position of said magnet carrier includes aligning a first pin receiver in said base with a second pin receiver in said magnet carrier and then inserting said pin into said first pin receiver and said second pin receiver.

18. The method of claim 17, wherein said second pin receiver includes a plurality of apertures provided at spaced locations through a stem of said magnet carrier and said method includes selecting a particular aperture of said plurality of apertures in which to insert said pin thereby adjusting (a) said position of said magnet carrier with respect to said base and (b) overall height of said magnet fastener.
